(19) United States
(12) Patent Application Publication
(10) Pub. No.: US 2003/0018465 A1
(43) Pub. Date: Jan. 23, 2003

(54) Mobile communication terminal and method

(76) Inventor: Yasushi Orita, Enzan-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/197,532

(22) Filed: Jul. 18, 2002

(30) Foreign Application Priority Data
Jul. 19, 2001 (JP) 2001-218971

(51) Int. Cl. G06F 17/28

(52) U.S. Cl. 704/2

(57) ABSTRACT

A destination storage stores a transmission destination and target language designating information which corresponds to the transmission destination. A target language storage stores an expression which corresponds to a predetermined expression and is written in a language differing from a language in which the predetermined expression is written. A determination part determines whether or not the input document data contains the predetermined expression. If the input document data contains the predetermined expression, a control part translates the predetermined expression into another language's expression which corresponds to the predetermined expression and is stored in the target language storage, on the basis of the stored target language designating information, thereby transmitting the translated document data.

### CROSS-REFERENCE TO RELATED APPLICATIONS

This application is based upon and claims the benefit of priority from the prior Japanese Patent Application No. 2001-218971, filed Jul. 19, 2001, the entire contents of which are incorporated herein by reference.

### BACKGROUND OF THE INVENTION

1. Field of the Invention

The present invention relates to a mobile communication terminal and method having a function for transmitting and receiving an electronic mail (E-mail).

2. Description of the Related Art

In an E-mail system for use in a conventional mobile communication system, in general, a user first inputs text data as document data to be transmitted, and then designates an address, subsequently transmitting the input text data to the designated address.

In this system, if there exist a plurality of users who receive an E-mail and some users do not understand the content of text data created by a user as sender, it is necessary to convert the text data into text data that can be understood by them, and also to execute different operations for transmitting different types of text data (written in different languages, for example).

These operations require a lot of time and effort.

### BRIEF SUMMARY OF THE INVENTION

It is an object of the invention to provide a mobile communication terminal and method, in which it is not necessary to create different text data items for different users as receivers or to transmit different text data items by different operations, thereby reducing the number of occasions of transmission.

To attain the object, according to an aspect of the invention, there is provided a mobile communication terminal capable of inputting, transmitting and receiving document data, comprising:

a destination storage configured to store a transmission destination and target language designating information which corresponds to the transmission destination;

a target language storage configured to store an expression which corresponds to a predetermined expression and is written in a language differing from a language in which the predetermined expression is written;

a determination part configured to determine whether or not the input document data contains the predetermined expression; and

a control part configured to translate the predetermined expression, if the input document data contains the predetermined expression, into another language's expression which corresponds to the predetermined expression and is stored in the target language storage, on the basis of the stored target language designating information, thereby transmitting the translated document data.

To attain the object, according to another aspect of the invention, there is provided a mobile communication method capable of inputting, transmitting and receiving document data, comprising:

storing a transmission destination and target language designating information which corresponds to the transmission destination;

storing an expression which corresponds to a predetermined expression and is written in a language differing from a language in which the predetermined expression is written;

determining whether or not the input document data contains the predetermined expression; and

translating the predetermined expression, if the input document data contains the predetermined expression, into another language's expression which corresponds to the predetermined expression, on the basis of the stored target language designating information, thereby transmitting the translated document data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram illustrating a mobile communication terminal according to an embodiment of the invention;

FIG. 2 is a table illustrating a phone book stored in the memory of the mobile communication terminal according to the embodiment of the invention;

FIG. 3 is a view illustrating the relationship between the control function of the mobile communication terminal of the embodiment of the invention and standard expression information stored in the memory of the terminal;

FIG. 4 is a flowchart useful in explaining the control function of the mobile communication terminal of the embodiment of the invention; and

FIG. 5 is a table illustrating the correspondence between designated addresses and target language designating information in the embodiment of the invention.

### DETAILED DESCRIPTION OF THE INVENTION

A mobile communication terminal and method according to an embodiment of the invention will be described with reference to the accompanying drawings.

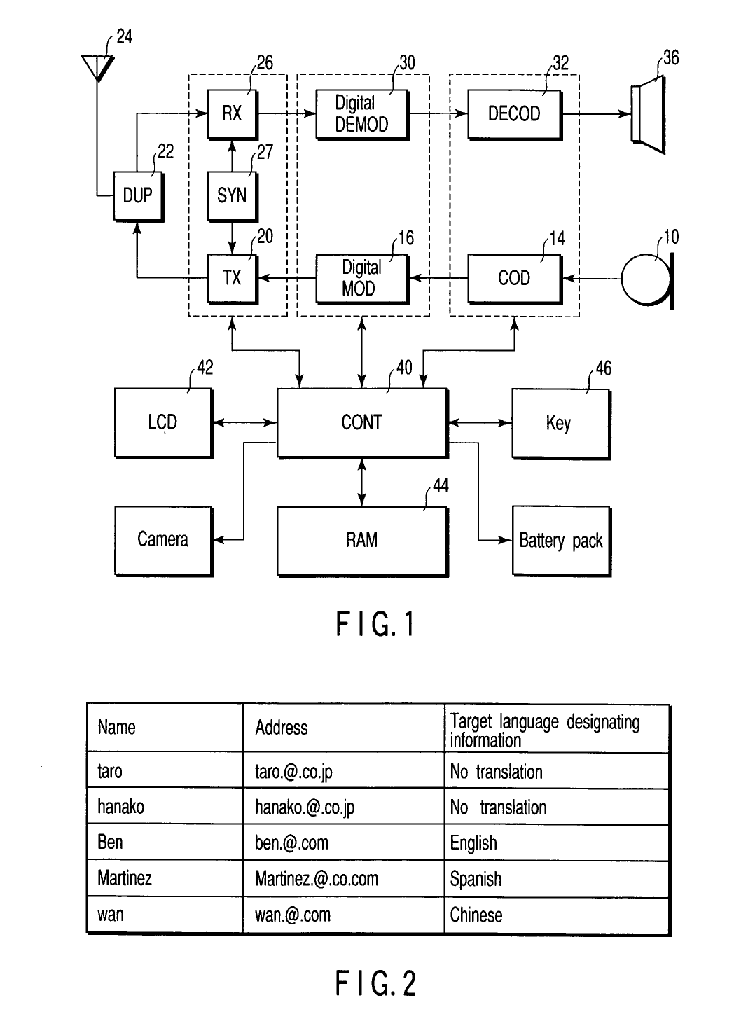

FIG. 1 is a block diagram illustrating the mobile communication terminal of the embodiment.

In FIG. 1, a to-be-transmitted speech signal output from a microphone 10 is converted into a digital signal and then compressed by a coder 14.

The compressed signal is digitally modulated by a digital modulator 16. The modulated signal is converted into a high-frequency signal by a radio transmitter 20 using a local signal output from a synthesizer 27.

The thus-converted signal is increased to a predetermined power level and supplied only to an antenna 24 via a duplexer 22. From the antenna 24, the signal is transmitted as a high-frequency radio signal.

On the other hand, a high-frequency radio signal from a base station is received by the antenna 24 and is supplied only to a radio receiving part 26 via the duplexer 22. The radio receiving part 26 amplifies the high-frequency signal and converts the amplified signal into a baseband signal using a local signal output from the synthesizer 27. The converted signal is input to a digital demodulator 30, where the converted signal is digitally demodulated.

The digitally demodulated signal is decoded, decompressed and converted into an analog signal by a decoder 32. This analog signal is output as sound through a loudspeaker 36.

A controller 40 has a function for controlling each part of the terminal, and also has a function, as a function related to the feature of the embodiment, for executing a conversion process concerning standard expressions.

Further, a memory (RAM) 44 connected to the controller 40 stores a phone book. An LCD (Liquid Crystal Display) 42, and a key part 46 as an input operation part are connected to the controller 40. The LCD 42 and key part 46 are used to input characters for creating an E-mail or updating the phone book, as well as to execute a display and input for a voice call.

FIG. 2 is a table illustrating a structure example of the phone book registered for executing control as the feature of the embodiment of the invention. As aforementioned, the phone book is stored in the memory 44, and contains names, addresses indicative of transmission destinations, and target language designating information items that correspond to the respective addresses and are used to designate languages into which each standard expression is to be translated in accordance with the user of each destination terminal.

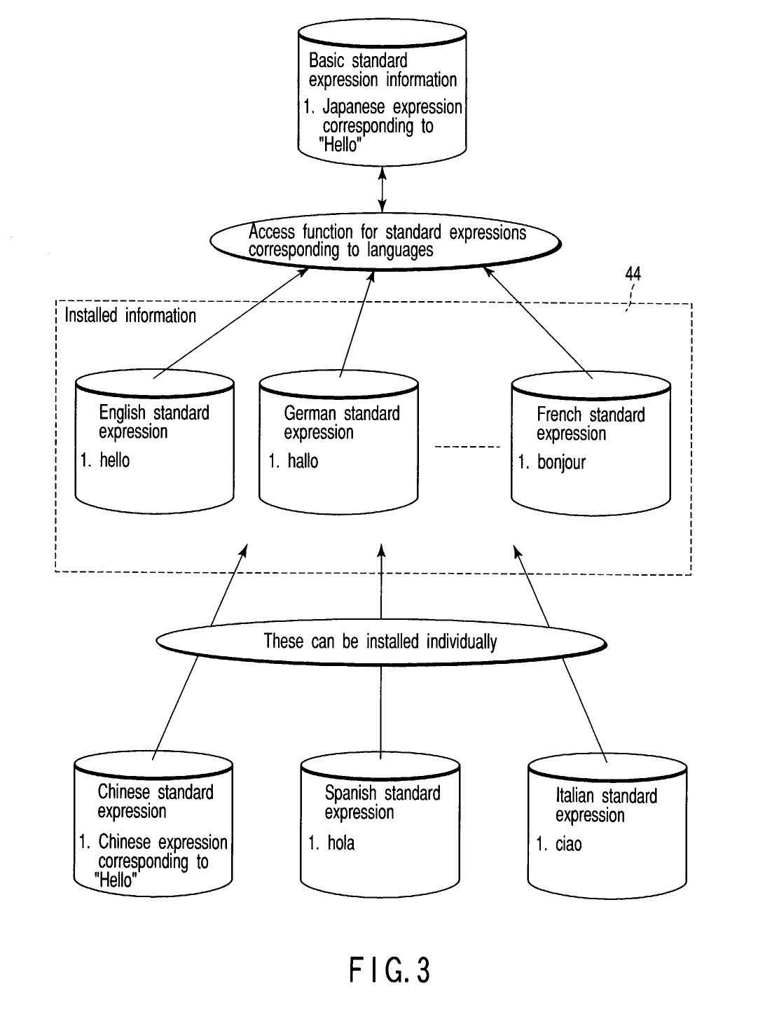

FIG. 3 is a view illustrating the relationship between the control function of the mobile communication terminal of the embodiment and standard expression information stored in the memory of the terminal. As seen from FIG. 3, the memory 44 stores standard expressions written in, for example, English, German, French, etc. corresponding to basic standard expressions (written in Japanese in this case).

In this description, expressions mean language expressions such as words, phrases, sentences, etc.

The user can register basic standard expressions written in another language, such as Chinese, Spanish, Italian, etc. as shown in FIG. 3.

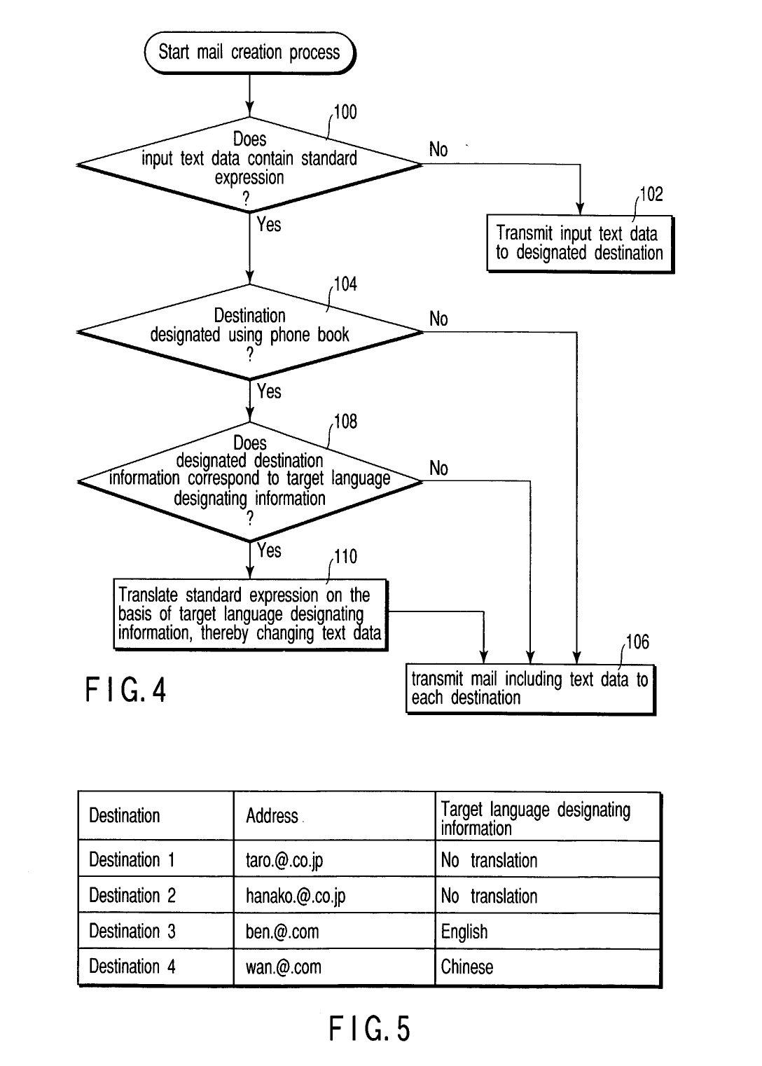

FIG. 4 is a flowchart useful in explaining the control function of the mobile communication terminal of the embodiment. When a mail creating process has been started, it is determined whether or not text data as input document data contains a standard expression corresponding to an expression stored in the memory 44 (step 100). If the text data does not contain the standard expression, the user designates a destination of transmission, and the input text data is transmitted in data's original state to the designated destination (step 102).

If it is determined that the input text data contains a standard expression corresponding to an expression stored in the memory 44, the user designates a transmission destination (step 104). At this time, if the designation of the destination is executed without using the phone book but by manual input, the input text data is transmitted in data's original state to each designated destination (steps 104 and 106).

If it is determined that the input text data contains a standard expression corresponding to an expression stored in the memory 44, and if the destination is designated using the phone book, it is determined, from the information contained in the phone book, whether or not a target language is designated by the target language designating information included in the information to be sent to the designated destination (step 108).

If no target language is designated by the target language designating information included in the information to be sent to the designated destination, the text data is transmitted in data's original state to each designated destination (step 106).

If, on the other hand, a target language is designated by the target language designating information, the standard expression contained in the input text data is translated on the basis of a corresponding target language designating information item, thereby changing the text data (step 110). After that, a mail containing the changed text data is transmitted to each designated destination (step 106).

The to-be-transmitted text data may be manually created by the user, or may be received text data itself. Further, the to-be-transmitted text data may be the data obtained by a user editing the received text data.

The received text data may be that downloaded from a web site or E-mail data from another terminal.

Referring now to FIG. 5, a description will be given of a case where input text data contains a standard expression corresponding to an expression stored in the memory 44.

FIG. 5 is a table illustrating the correspondence between designated addresses and target language designating information in the embodiment.

FIG. 5 illustrates a case where destinations 1, 2, 3 and 4 are designated for input text data, and no target language designating information is registered in the phone book for the destinations 1 and 2 (i.e., “No Translation” is designated for the destinations). Therefore, the input text data itself is used and stored as a mail file.

Concerning Ben as the destination 3, the corresponding target language designating information indicates, according to the phone book shown in FIG. 2, that the target language is English. If the controller confirms that the memory 44 stores the English version of a standard expression included in the to-be-sent information, the controller 40 translates the standard expression (e.g., a Japanese word corresponding to hello) into a corresponding English word (Hello). The new text data including the translated expression is used and stored as a mail file in the memory 44.

Concerning wan as the destination 4, the corresponding target language designating information indicates, according to the phone book, that the target language is Chinese. If the controller confirms that the memory 44 stores no Chinese version of a standard expression included in the to-be-sent information, the controller 40 inputs “No Translation”, and uses and stores the input text data itself as a mail file.

The resultant mail files are sequentially transmitted to the destinations.

It is preferable that expressions written in foreign languages that correspond to each standard expression should be installed as shown in FIG. 3. It is also preferable that the user should prepare and register other standard expression information and store the standard expression information in relation to foreign-language expressions.

In addition, the user may select one or more standard expressions from predetermined ones.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile communication terminal capable of inputting, transmitting and receiving document data, comprising:
a destination storage configured to store a transmission destination and target language designating information which corresponds to the transmission destination;
a target language storage configured to store an expression which corresponds to a predetermined expression and is written in a language differing from a language in which the predetermined expression is written;
a determination part configured to determine whether or not the input document data contains the predetermined expression; and
a control part configured to translate the predetermined expression, if the input document data contains the predetermined expression, into another language's expression which corresponds to the predetermined expression and is stored in the target language storage, on the basis of the stored target language designating information, thereby transmitting the translated document data.

2. The mobile communication terminal according to claim 1, wherein the target language storage stores expressions written in various languages and corresponding to the predetermined expression.

3. The mobile communication terminal according to claim 1, wherein the determination part determines whether or not the input document data contains a predetermined expression selected by user's instruction.

4. The mobile communication terminal according to claim 1, wherein the target language storage can register an expression written in a second language, the expression corresponding to a predetermined expression written in a first language.

5. A mobile communication method capable of inputting, transmitting and receiving document data, comprising:
storing a transmission destination and target language designating information which corresponds to the transmission destination;
storing an expression which corresponds to a predetermined expression and is written in a language differing from a language in which the predetermined expression is written;
determining whether or not the input document data contains the predetermined expression; and
translating the predetermined expression, if the input document data contains the predetermined expression, into another language's expression which corresponds to the predetermined expression, on the basis of the stored target language designating information, thereby transmitting the translated document data.

6. The mobile communication method according to claim 5, wherein storing the expression comprises storing expressions written in various languages and corresponding to the predetermined expression.

7. The mobile communication method according to claim 5, wherein determining comprises determining whether or not the input document data contains a predetermined expression selected by user's instruction.

8. The mobile communication method according to claim 5, wherein storing the expression comprises registering an expression written in a second language, the expression corresponding to a predetermined expression written in a first language.
